(19) United States
(12) Patent Application Publication
(10) Pub. No.: US 2026/0116302 A1
(43) Pub. Date: Apr. 30, 2026

(54) CAMERA MONITOR SYSTEM WITH WIDE-ANGLE INDIRECT VIEW WITH MULTIPLE CAMERAS AND COMBINED VIEWS

(71) Applicant: STONERIDGE ELECTRONICS AB, Solna (SE)

(72) Inventors: Onno OENEMA, AG Zutphen (NL); Alfred VAN DEN BRINK, Barneveld (NL)

(21) Appl. No.: 19/161,515

(22) PCT Filed: Aug. 16, 2024
(86) PCT No.: PCT/EP2024/073146

§ 371 Date: Sep. 2, 2025

(51) Int. Cl. B60R 1/27; B60R 11/04

(52) U.S. Cl. CPC B60R 1/27; B60R 11/04; B60R 2300/105; B60R 2300/303; B60R 2300/307; B60R 2300/802; B60R 2300/8033

(57) ABSTRACT

First and second cameras include first and second optical axes that intersect one another. The first and second cameras respectively have first and second image capture units that respectively include first and second warp maps that provide first and second fields of view. Third and fourth cameras are configured in a similar manner to the first and second cameras. An image processing module combines the first and second fields of view based upon first and second warp maps to provide a first combined seamless view, and combines the third and fourth fields of view based upon third and fourth warp maps to provide a second combined seamless view. At least one display depicts the first and second combined seamless views to provide a vehicle surround view about a vehicle.

### TECHNICAL FIELD

This disclosure relates to a camera monitor system (CMS) for a vehicle, and specifically to a CMS and method of combining views to one another to provide a vehicle surround view.

### BACKGROUND

Mirror replacement systems, and camera systems for supplementing mirror views, are utilized in commercial on-highway and off-highway (e.g., “machines”) vehicles to enhance the ability of a vehicle operator to see a surrounding environment. Camera monitor systems (CMS) utilize one or more cameras to provide an enhanced field of view to a vehicle operator. In some examples, the camera systems cover a larger field of view than a conventional mirror, or include views that are not fully obtainable via a conventional mirror.

For machine operators who drive on earth moving, agricultural, and industrial machines, a view of the surroundings is required according regulations for construction machines (e.g. ISO 20474 and ISO5006) and agricultural machines (EN167/2013 and ISO5721 and ISO5006). The views surrounding the machine should be free of blind spots, which occur in most available systems. In one typical example surround view system, a “bird's eye view” (BEV) illustrates the entire vehicle itself from above as well as 360° view around the vehicle. This is accomplished using four cameras, with each camera placed on each of the four flanks of the machine (i.e., front center of vehicle, right center of vehicle, rear center of vehicle, left center of vehicle). In this configuration the optical axes of the four cameras are a far distance apart of each other.

All four fields of view are then stitched together. In order to estimate image alignment when stitching, algorithms are needed to determine the appropriate mathematical model relating pixel coordinates in one image to pixel coordinates in another. Algorithms dynamically (in real-time) combine direct pixel-to-pixel comparisons with gradient descent (and other optimization techniques) to estimate these parameters. Distinctive features can be found in each image and then matched to establish correspondences between pairs of images, again, performed in real-time. Because of this real-time estimation, stitching typically requires highly capable algorithms running on complex costly hardware. Nonetheless, the areas where the adjacent fields of view are stitched are often blurry or invisible due to limitations in stitching algorithms, resulting in blind spots. This may violate ISO 5006, ISO 5721 and ISO 14401, which sets forth visibility requirements that prohibit blind spots.

### SUMMARY

In one exemplary embodiment, a camera monitor system (CMS) for a vehicle includes first and second cameras that respectively include first and second optical axes that intersect one another, the first and second cameras respectively have first and second image capture units that respectively include first and second warp maps and configured to provide first and second fields of view. Third and fourth cameras respectively include third and fourth optical axes that intersect one another, the third and fourth cameras respectively have third and fourth image capture units that respectively include third and fourth warp maps and configured to provide third and fourth fields of view. A controller is in communication with the first, second, third and fourth cameras, the controller includes an image processing module that is configured to combine the first and second fields of view based upon first and second warp maps to provide a first combined seamless view, and image processing module that is configured to combine the third and fourth fields of view based upon third and fourth warp maps to provide a second combined seamless view. At least one display is in communication with the controller, the at least one display is configured to depict the first and second combined seamless views to provide a vehicle surround view about a vehicle.

In a further embodiment of any of the above, the first and second combined seamless views are provided on a common display.

In a further embodiment of any of the above, the first and second combined seamless views are respectively arranged in an L-shape and inverted L-shape. The first and second combined seamless views are displayed together to provide a quadrangularly shaped vehicle surround view.

In a further embodiment of any of the above, the vehicle is substantially omitted from the vehicle surround view.

In a further embodiment of any of the above, the common display is arranged in a landscape orientation.

In a further embodiment of any of the above, the common display includes a third displayed view that is adjacent to the vehicle surround view.

In a further embodiment of any of the above, the first and second locations are on opposite corners of the vehicle.

In a further embodiment of any of the above, the first and second fields of view respectively provide a front side of vehicle field of view and a first lateral side of vehicle field of view. The third and fourth fields of view respectively provide a rear side of vehicle field of view and a second lateral side of vehicle field of view.

In a further embodiment of any of the above, the first and second optical axes are at a first obtuse angle that faces the vehicle, and the third and fourth optical axes are at a second obtuse angle that faces the vehicle.

In a further embodiment of any of the above, each of the first, second, third and fourth cameras provide at least a 180° field of view.

In a further embodiment of any of the above, the first and second cameras are within 30 cm of one another, and the third and fourth cameras are within 30 cm of one another.

In a further embodiment of any of the above, the first and second optical axes are in a common plane with one another, and the third and fourth optical axes are in a common plane with one another.

In a further embodiment of any of the above, the second and third fields of view overlap one another in a first overlapping region. The fourth and first fields of view overlap one another in a second overlapping regions. Each of the first and second overlapping regions remain unstitched.

In another exemplary embodiment, a method of providing a vehicle surround view includes a) capturing first and second fields of view respectively with first and second image capture units that are arranged at a first location, the first and second image capture units respectively have optical first and second optical axes that intersect one another and respectively include first and second warp maps, b) capturing third and fourth fields of view respectively with third and fourth image capture units that are arranged at a second location, the third and fourth fields image capture units respectively have third and fourth optical axes that intersect one another and respectively include third and fourth warp maps, c) combining the first and second fields of view based upon the first and second warp maps to provide a first combined seamless view, d) combine the third and fourth fields of view based upon the third and fourth warp maps to provide a second combined seamless view, and e) displaying the first and second combined seamless views to provide a vehicle surround view about a vehicle.

In a further embodiment of any of the above, step e) includes displaying the first and second combined seamless views on a common display and respectively arranged in an L-shape and inverted L-shape. The first and second combined seamless views are displayed to provide a quadrangularly shaped vehicle surround view. The vehicle is substantially omitted from the vehicle surround view.

In a further embodiment of any of the above, the first and second locations are on opposite corners of the vehicle. The first and second fields of view respectively provide a front side of vehicle field of view and a first lateral side of vehicle field of view, and the third and fourth fields of view respectively provide a rear side of vehicle field of view and a second lateral side of vehicle field of view.

In a further embodiment of any of the above, the second and third fields of view overlap one another in a first overlapping region. The fourth and first fields of view overlap one another in a second overlapping region. Each of the first and second overlapping regions remain unstitched.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1A is a left side view of an earth moving machine with a disclosed camera monitoring system (CMS) and its camera configuration.

FIG. 1B is a right side view of the earth moving machine shown in FIG. 1A.

FIG. 2 is a schematic of an example CMS.

FIG. 3 schematic of four fields of view using the disclosed CMS and its camera configuration.

FIG. 4 is a schematic of a displayed view of first and second combined views of the four fields of view.

FIGS. 5A-5D respectively correspond to captured images from the four fields of view.

FIG. 6 illustrates a display of the first and second combined views using the captured images shown in FIGS. 5A-5D.

FIG. 7 illustrates a portrait display of the first and second combined views for the CMS of the earth moving machine shown in FIGS. 1A and 1B.

FIG. 8 illustrates a similar display to FIG. 7, but arranged in a landscape orientation.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

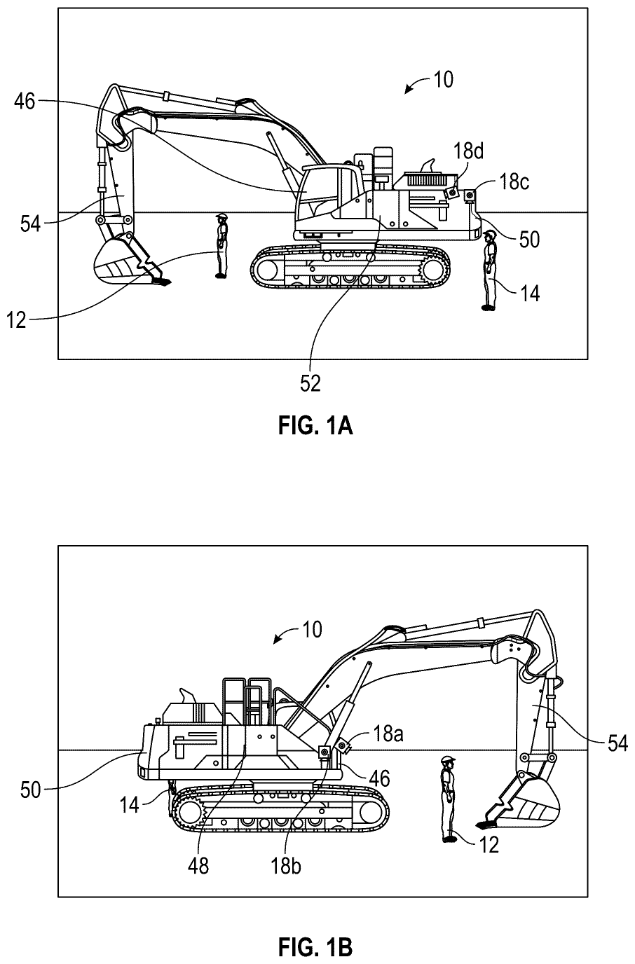

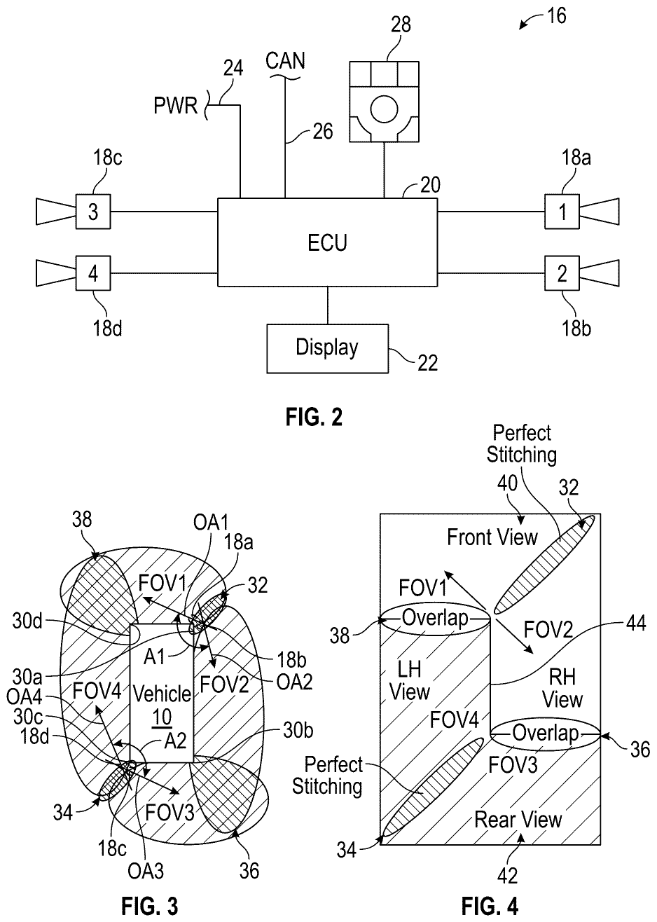

FIGS. 1A and 1B respectively illustrate left-and right-side views of a vehicle 10, such as an earth moving machine. The vehicle has a front side 46, a right side 48, a back side 50 and a left side 52. Off-highway machines typically include one or more movable implements, such as a backhoe 54. As is typical of most applications, the vehicle 10 may operate in a crowded environment with various objects (e.g., people 12 and 14) with which collisions must be avoided. A reliable camera monitor system (CMS, at 16 in FIG. 2) provides a surround view of the vehicle 10 free from blind spots so that the implements and objects remain in view according to applicable regulations (e.g., ISO 5006 and ISO 14401).

Referring to FIG. 2, the CMS 16 includes first, second, third and fourth cameras 18a, 18b, 18c, 18d (collectively, “cameras 18”) in communication with a controller, such as ECU 20. The ECU 20 may be a hardware device for executing software, particularly software stored in memory. The ECU 20 can be a custom made or commercially available processor, a central processing unit (CPU), an auxiliary processor among several processors associated with the controller, a semiconductor-based microprocessor (in the form of a microchip or chip set) or generally any device for executing software instructions.

In terms of hardware architecture, such a computing device can include a processor, memory, and one or more input and/or output (I/O) device interface(s) that are communicatively coupled via a local interface. The local interface can include, for example but not limited to, one or more buses (e.g., CAN bus 26) and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the ECU 20 is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

The CMS 16 receives power 24 from the vehicle 10. ECU 20 is in communication with an input device 28, which may be used by the operator to customize and control the CMS 16. The ECU 20 may include an image processing module that can combine images from the cameras in a known manner to combine more than one field of view into a seamless displayed image, for example, on one or more displays 22. The display(s) 22 are located in the vehicle's cab within easy view by the operator.

The disclosed configuration of cameras 18 is unique in that cameras are paired in close proximity to one another and arranged to enable precise combination of views without expensive stitching while eliminating blind spots found in the typical flanked bird's eye view camera configurations. In a typical BEV system, the optical axes of the cameras do not intersect anywhere (in space around/above the machine). According to mathematical principles, this will always result in either a vague, blurred overlapping combined image or an omission in the combined image. By way of contrast, in the disclosed system two cameras are placed in close proximity such that the optical axes intersect. Area 32 is the area with seamless image overlap for which the cameras warp maps are statically correlated to one another (i.e., no dynamic stitching used). By having the optical axes intersection point as close as possible to the image sensors (image capture units), which are inside the cameras, the combined images of the two close-proximity cameras is as if one image is established (e.g., like two closely situated eyes acting like a single retina of an eye).

Each camera 18 includes a lens having an optical axis (OA1, OA2, OA3, OA4) and an image capture unit that captures an image in the camera's field of view. Each image capture unit has a warp map, which is a predefined mapping of 3D space to the pixels on the image capture unit.

In the disclosed example, each of the first, second, third and fourth cameras 18a-18d provide at least a 180° field of view. But, unlike flanked BEV camera configurations, the optical axes are not perpendicular to their respective side of the vehicle. In the example shown in FIGS. 1A and 1B, first and second cameras 18a, 18b are arranged at one corner of the vehicle 10, and the third and fourth cameras 18c, 18d are arranged at an opposite corner. The second and third fields of view FOV2, FOV3 overlap one another in a first overlapping region 36 (adjacent corner 30b), and the fourth and first fields of view FOV4, FOV1 overlap one another in a second overlapping region 38 (adjacent corner 30d).

Referring to FIGS. 1A, 1B and 3, the first and second cameras 18a, 18b are arranged to face away from one another (do not face in the same general direction) and respectively include intersecting first and second optical axes OA1, OA2 arranged in a common plane (arrows in FIG. 3). The first and second optical axes OA1, OA2 form a first angle A1 that is obtuse and faces the vehicle 10. The first and second image capture units respectively providing first and second fields of view FOV1, FOV2 that intersect one another at 32. To ensure that a seamless combined image is possible, the first and second image capture units are arranged in close proximity to one another at a first location (e.g., within 30 cm of one another at one corner 30a of the vehicle 10). If possible, the first and second cameras 18a, 18b are arranged much closer to one another and on a common bracket that enables the cameras to be more easily aligned with one another. As a result, the first and second warp maps of the first and second cameras 18a, 18b can be linked together in a predefined manner where the pixels on their respective image capture units overlap at the intersection 32.

In a similar manner, the third and fourth cameras 18c, 18d are arranged to face away from one another (do not face in the same general direction) and respectively include intersecting third and fourth optical axes OA3, OA4 arranged in a common plane (arrows in FIG. 3). The third and fourth optical axes OA3, OA4 form a second angle A2 that is obtuse and faces the vehicle 10. The third and fourth image capture units respectively providing third and fourth fields of view FOV3, FOV4 that intersect one another at 34. To ensure that a seamless combined image is possible, the third and fourth image capture units are arranged in close proximity to one another at a first location (e.g., within 30 cm of one another at one corner 30c of the vehicle 10). As a result, the third and fourth warp maps of the third and fourth cameras 18c, 18d can be linked together in a predefined manner where the pixels on their respective image capture units overlap at the intersection 34.

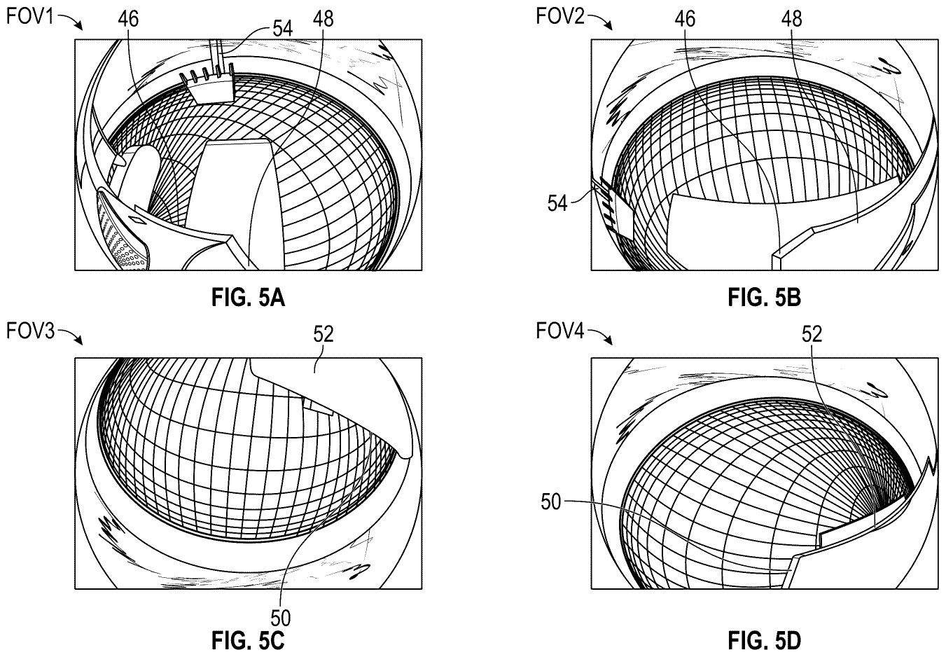

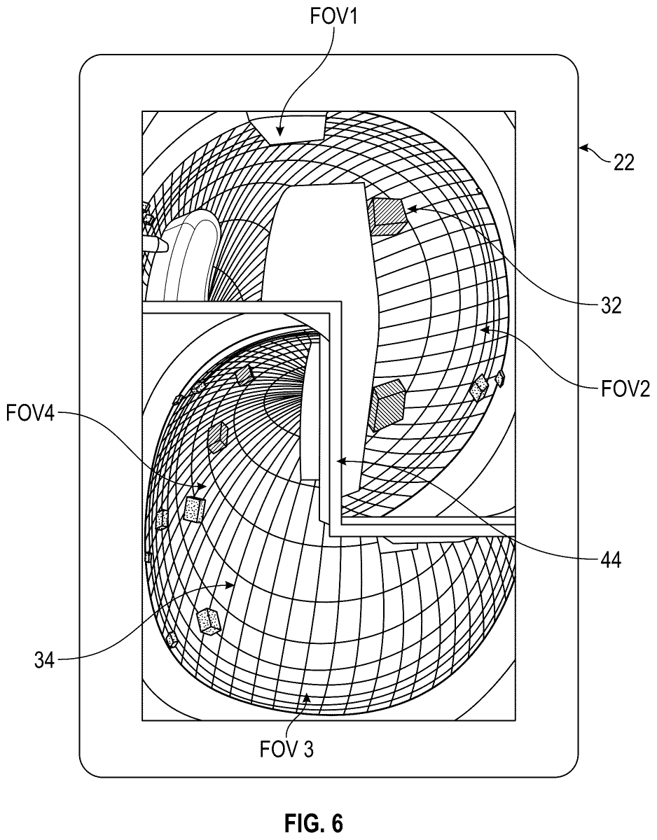

Arranging intersecting optical axes in this manner permits predefined static warp maps on each camera image can be used to ensure that every pair of two images result in a seamless bigger image because their warp maps have been statically linked to one another in a predefined manner. The warp maps from each camera are schematically illustrated by the line grids in FIGS. 5A-5D, and the combination of the warp maps from adjacent cameras into combined images is shown in FIG. 6. These warp maps can run on simpler hardware, thus realizing a more cost-effective solution.

It should be understood that other types of sensors may be used instead of or in addition to the cameras 18. For example, radar sensors, ultrasonic sensors, LiDar sensors, vibration sensors and/or other sensors may be similarly arranged as described in this disclosure to provide a surround “view” free from blind spots, The specific position of the camera set (camera 1 and 2) and the camera set (camera 3 and 4) can be used for additional aspects of safety, object detection and warnings. The other sensors may be co-located with the cameras, for example, to provide similar location extrinsics and bore sights for ease of sensor fusion.

The image processing module combines the first and second fields of view FOV1, FOV2 based upon the respective camera warp maps to provide a first combined view 40 at image intersection 32, as shown in FIG. 4. The image processing module combines the third and fourth fields of view FOV3, FOV4 using static warp maps to provide a second combined view at image intersection 34. The display 22 depicts the first and second combined views 40, 42 to provide a vehicle surround view about a vehicle 10. In the example, each of the first and second overlapping regions 36, 38 remain unstitched, and the intersections 32, 34 are combined based upon static warp maps instead of using dynamic stitching. Since the optical axes OA3, OA4 of the second and third cameras 18b, 18c relative to one another are far apart combining or stitching the first overlapping region 36 would result in the same blurring image or missed objects as the prior art flanked BEV camera configuration, giving a false impression of an accurate vehicle surround view. The same is true of the second overlapping region 38 of the fourth and first cameras 18d, 18a.

In one example, the first and second combined views 40, 42 are provided on a common display. Since the cameras are combined in pairs but otherwise unstitched, the first and second stitched views 40, 42 can be nested on the display 22, providing a Z-shaped image boundary 44 between the first and second combined views 40, 42. As shown in FIG. 4, the first and second combined views 40, 42 are respectively arranged in an L-shape and an inverted L-shape so that the first and second combined views 40, 42 can be displayed together to provide a quadrangularly shaped vehicle surround view. The vehicle 10 can be substantially omitted (no BEV view of vehicle) from the vehicle surround view since the there is no image continuity in the unstitched first and second overlapping areas 36, 38. This also enables a larger overall image to be displayed on the display 22.

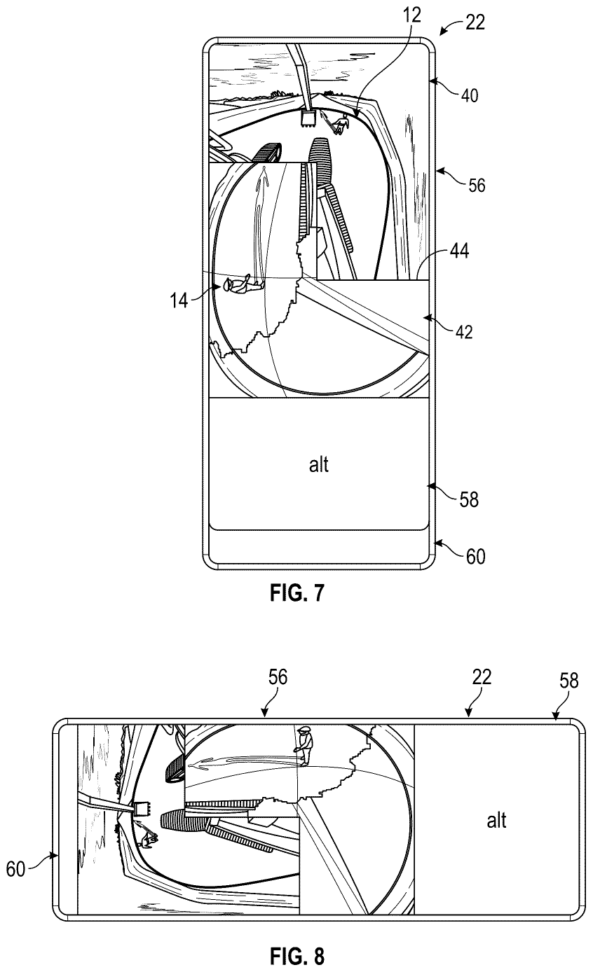

FIGS. 5A-5D respectively illustrate images of fields of view FOV1-FOV4 from cameras 18a-18d of a vehicle. Images captured by the image capture units are warped or distorted by the lenses such that dewarping and/or other image correction is used, as is known, before displaying the corrected images. FIG. 6 illustrates the combined images of FIGS. 5A-5D with seamless views at intersections 32, 34. FIG. 7 illustrates the fields of view captured by the camera 18a-18d for the vehicle 10 shown in FIGS. 1A-1B. The people 12, 14 are clearly visible to the operator in a situation where they may be lost by a typical flanked BEV camera configuration.

In the example shown in FIG. 7, both first and second combined views 40, 42 are depicted on a common display 22 arranged in a portrait orientation. An additional view 58 may be provided on the same display 22 adjacent to the first and second combined views 40, 42. A display input/output 60 may also be provided. Of course, the first and second combined views 40, 42 can be depicted on separate displays if desired. In another example, the first and second combined views 40, 42 are depicted on a common display 22 arranged in a landscape orientation 56, as shown in FIG. 8.

The displayed views shown in FIGS. 6-8 have not been dewarped (at least fully) as this is not a requirement for machine displays. It should be understood that the combined seamless images could be dewarped before displaying, if desired.

In operation, the CMS 16 captures first and second fields of view FOV1 and FOV2 respectively with first and second image capture units arranged at a first location (e.g., corner 30a). The first and second optical axes intersect one another. The CMS 16 also captures third and fourth fields of view FOV3 and FOV4 respectively with third and fourth image capture units arranged at a second location (e.g., corner 30c). The third and fourth optical axes intersect one another. The first and second fields of view FOV1 and FOV2 are combined to provide the first combined seamless view 40, and the third and fourth fields of view FOV3 and FOV4 are combined to provide the second combined seamless view 42. The CMS 16 the displays the first and second combined seamless views 40, 42 to provide a vehicle surround view about the vehicle 10.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A camera monitor system (CMS) for a vehicle, comprising:
first and second cameras respectively including first and second optical axes that intersect one another, the first and second cameras respectively having first and second image capture units respectively including first and second warp maps and configured to provide first and second fields of view;
third and fourth cameras respectively including third and fourth optical axes that intersect one another, the third and fourth cameras respectively having third and fourth image capture units respectively including third and fourth warp maps and configured to provide third and fourth fields of view;
a controller in communication with the first, second, third and fourth cameras, the controller including an image processing module configured to combine the first and second fields of view based upon first and second warp maps to provide a first combined seamless view, and image processing module configured to combine the third and fourth fields of view based upon third and fourth warp maps to provide a second combined seamless view; and
at least one display in communication with the controller, the at least one display configured to depict the first and second combined seamless views to provide a vehicle surround view about a vehicle.

2. The CMS of claim 1, wherein the first and second combined seamless views are provided on a common display.

3. The CMS of claim 2, wherein the first and second combined seamless views are respectively arranged in an L-shape and inverted L-shape, the first and second combined seamless views displayed together to provide a quadrangularly shaped vehicle surround view.

4. The CMS of claim 3, wherein the vehicle is substantially omitted from the vehicle surround view.

5. The CMS of claim 3, wherein the common display is arranged in a landscape orientation.

6. The CMS of claim 3, wherein the common display includes a third displayed view adjacent to the vehicle surround view.

7. The CMS of claim 1, wherein the first and second locations are on opposite corners of the vehicle.

8. The CMS of claim 7, wherein the first and second fields of view respectively provide a front side of vehicle field of view and a first lateral side of vehicle field of view, and the third and fourth fields of view respectively provide a rear side of vehicle field of view and a second lateral side of vehicle field of view.

9. The CMS of claim 8, wherein the first and second optical axes are at a first obtuse angle that faces the vehicle, and the third and fourth optical axes are at a second obtuse angle that faces the vehicle.

10. The CMS of claim 9, wherein each of the first, second, third and fourth cameras provide at least a 180° field of view.

11. The CMS of claim 7, wherein the first and second cameras are within 30 cm of one another, and the third and fourth cameras are within 30 cm of one another.

12. The CMS of claim 1, wherein the first and second optical axes are in a common plane with one another, and the third and fourth optical axes are in a common plane with one another.

13. The CMS of claim 1, wherein the second and third fields of view overlap one another in a first overlapping region, the fourth and first fields of view overlap one another in a second overlapping regions, wherein each of the first and second overlapping regions remain unstitched.

14. A method of providing a vehicle surround view, comprising:
a) capturing first and second fields of view respectively with first and second image capture units arranged at a first location, the first and second image capture units respectively having optical first and second optical axes that intersect one another and respectively include first and second warp maps;
b) capturing third and fourth fields of view respectively with third and fourth image capture units arranged at a second location, the third and fourth fields image capture units respectively having third and fourth optical axes that intersect one another and respectively include third and fourth warp maps;
c) combining the first and second fields of view based upon the first and second warp maps to provide a first combined seamless view;
d) combine the third and fourth fields of view based upon the third and fourth warp maps to provide a second combined seamless view; and
e) displaying the first and second combined seamless views to provide a vehicle surround view about a vehicle.

15. The method of claim 14, wherein step e) includes displaying the first and second combined seamless views on a common display and respectively arranged in an L-shape and inverted L-shape, the first and second combined seamless views are displayed to provide a quadrangularly shaped vehicle surround view, wherein the vehicle is substantially omitted from the vehicle surround view.

16. The method of claim 14, wherein the first and second locations are on opposite corners of the vehicle, wherein the first and second fields of view respectively provide a front side of vehicle field of view and a first lateral side of vehicle field of view, and the third and fourth fields of view respectively provide a rear side of vehicle field of view and a second lateral side of vehicle field of view.

17. The method of claim 16, wherein the second and third fields of view overlap one another in a first overlapping region, the fourth and first fields of view overlap one another in a second overlapping regions, wherein each of the first and second overlapping regions remain unstitched.
